(19) United States
(12) Patent Application Publication
(10) Pub. No.: US 2005/0031320 A1
(43) Pub. Date: Feb. 10, 2005

(54) Method, medium, and system for identifying a frame number

(75) Inventor: Kyeong-Yong Yoon, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/885,737

(22) Filed: Jul. 8, 2004

(30) Foreign Application Priority Data
Aug. 8, 2003 (KR) 2003-55018

(51) Int. Cl. H04N 5/85

(52) U.S. Cl. 386/126

(57) ABSTRACT

A method, medium, and system for identifying a frame number for a data decoding system requiring less frame sync identification data (ID) than frame numbers, including detecting a sync ID of a current frame and/or sync IDs of previous frames from input data, and identifying a current frame number according to whether a number of matching sync IDs in a combination, considering sequence, of a detected sync ID of the current frame and/or sync IDs of previous frames is equal to or greater than a predetermined number. Even when, in a stable state, an error-free current frame sync ID does not exist, or even when sync IDs of frames being compared are not continuously detected, a frame number can be recognized if the number of matching sync IDs, among sync IDs of frames being compared, is equal to or greater than a predetermined number, by using uniqueness of a combination, considering sequence, of the current frame sync ID and sync IDs of previous frames.

### CROSS-REFERENCE TO RELATED APPLICATIONS

This application claims priority benefit of Korean Patent Application No. 2003-55018, filed on Aug. 8, 2003, the disclosure of which is incorporated herein by reference in its entirety.

### BACKGROUND OF THE INVENTION

1. Field of the Invention

The present invention relates to a frame number identifying method, and more particularly, to a method of faster and more stably identifying a frame number when data is decoded.

2. Description of the Related Art

In a data decoding system having less frame sync identification data (hereinafter referred to as an ID) than frame numbers, a sync ID of a current frame and sync IDs of previous frames are needed to identify a current frame number.

That is, in order to identify a current frame number, the sync ID of the current frame is necessarily needed, with the current frame number being identified by a combination of this current frame sync ID and sync IDs of the previous frames. Conventionally, in a data decoding circuit for optical discs, such as DVD-ROM/RAM, the number of sync IDs of frames compared is variable (4, 6, etc.), but detecting of a current frame sync ID is still needed. In addition, error-free sync IDs should be detected continuously at predetermined times (4 times, 6 times, etc.).

FIG. 1 is a table explaining a conventional method for identifying a frame number. Referring to FIG. 1, identification of a current frame is performed by combining an error-free current frame sync ID and a predetermined number of error-free preceding frame sync IDs. Assuming that the predetermined number is m and the current frame is a k-th frame, the error-free k-th frame sync ID (the current frame sync ID), the (k-1)-th frame sync ID, the (k-2)-th frame sync ID, . . . , and the (k-m+1)-th frame sync ID should all be detected so that the frame number of the k-th frame can be reasonably identified. According to the characteristic of a system, the value of m may vary, but the continuity of the error-free current frame sync ID (k-th sync ID) and the error-free preceding frame sync IDs is essential.

In addition, even when the continuity is not considered and a frame is identified considering only a combination of q frame sync IDs, among m frame sync IDs (here, q<m), the k-th (current) frame sync ID should still be detected.

Accordingly, in reasonably identifying the k-th frame, if there is only one error when m sync IDs are continuously being detected, the frame number cannot be identified. That is, the k-th frame sync ID is essential and error-free m sync IDs should be continuously detected so that identification of a frame number can be enabled. Even when there are sync IDs for the (k-1)-th through (k-m+1)-th frames, the k-th frame number cannot be recognized without k-th frame sync ID.

Due to these characteristics, in order to change from an initial driving state of a system or an unlock state, where the reliability of detected data is degraded, to a lock state, where the detected data is stable enough to be relied upon, a predetermined number of error-free sync IDs should be continuously detected. If error-free sync IDs are not detected continuously, then the speed will be degraded as the driving state must be switched to the stable state.

Due to the characteristics of error-free sync IDs needing to be continuously detected or that a current frame sync ID needs to be detected, the frame number cannot be identified with for a frame sync ID pattern repeating ‘normal state—error—normal state—error’, even when the system is in lock state.

In addition, when the current frame sync ID cannot be detected because frame data is broken, due to the characteristic of an unstable channel or system, the conventional frame number identifying method cannot identify the current frame number accurately and therefore has to simply increase or predict the current frame number considering the increasing tendency from a previous frame defined in specifications.

### SUMMARY OF THE INVENTION

Embodiments of the present invention provide for a method of identifying a frame number when data is decoded in a digital data decoding system. Embodiments of the present invention further provide a method of identifying a frame number when data is decoded for a high-density optical disc system.

Embodiments of the present invention also provide for a method of faster and more stably identifying a current frame number even when an error-free current frame sync identification data (ID) is not detected. In addition, Embodiments of the present invention are also capable of restoring a current frame number even when error-free frame sync IDs are not detected continuously.

Embodiments of the present invention also provide for a method of effectively identifying a frame number by using a uniqueness of a combination considering sequences of the current frame sync ID and sync IDs of previous frames, in a data decoding system having less frame sync IDs than frame numbers.

Additional aspects and/or advantages of the invention will be set forth in part in the description which follows and, in part, will be obvious from the description, or may be learned by practice of the invention.

To achieve the above and/or other aspects and advantages, embodiments of the present invention include a data decoding method, including detecting sync identification data (ID) of a current frame and/or sync IDs of previous frames from input data, and identifying a frame number according to whether a number of matching sync IDs in a combination, considering a sequence of detected sync ID of the current frame and/or sync IDs of previous frames, is equal to or greater than a predetermined number.

To achieve the above and/or other aspects and advantages, embodiments of the present invention include a frame number identifying method of a data decoding system having less frame sync IDs than frame numbers for input data, including detecting a sync ID of a current frame and/or sync IDs of previous frames from the input data, and identifying a frame number according to whether a number of matching sync IDs in a combination is equal to or greater than a predetermined number r, by using a uniqueness within the combination, considering a sequence of m sync IDs including the current frame and/or sync IDs of previous frames.

Further, in the identifying of the frame number, even when the sync ID of the current frame is not detected, the frame number may be identified. Similarly, in the identifying of the frame number, even when the detected frame sync IDs are not continuous, the frame number may also be identified.

To achieve the above and/or other aspects and advantages, embodiments of the present invention include a medium, including computer readable code to control a detecting of sync identification data (ID) of a current frame and/or sync IDs of previous frames from input data, and identifying of a frame number according to whether a number of matching sync IDs in a combination, considering a sequence of detected sync ID of the current frame and/or sync IDs of previous frames, is equal to or greater than a predetermined number.

To achieve the above and/or other aspects and advantages, embodiments of the present invention may further include a medium, including computer readable code controlling a frame number identifying operation of a data decoding system having less frame sync IDs than frame numbers for input data, controlling a detecting of a sync ID of a current frame and/or sync IDs of previous frames from the input data, and an identifying of a frame number according to whether a number of matching sync IDs in a combination is equal to or greater than a predetermined number r, by using a uniqueness within the combination, considering a sequence of m sync IDs including the current frame and/or sync IDs of previous frames.

To achieve the above and/or other aspects and advantages, embodiments of the present invention include a data decoding system, including a detector to detect sync identification data (ID) of a current frame and/or sync IDs of previous frames from input data, and an identifier to identify a frame number according to whether a number of matching sync IDs in a combination, considering a sequence of detected sync ID of the current frame and/or sync IDs of previous frames, is equal to or greater than a predetermined number.

Lastly, To achieve the above and/or other aspects and advantages, embodiments of the present invention include a data decoding system, wherein input data includes less frame sync IDs than frame numbers, including a detector to detect a sync ID of a current frame and/or sync IDs of previous frames from the input data, and an identifier to identify a frame number according to whether a number of matching sync IDs in a combination is equal to or greater than a predetermined number r, by using a uniqueness within the combination, considering a sequence of m sync IDs including the current frame and/or sync IDs of previous frames.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a table explaining a conventional method for identifying a frame number;

FIG. 2 is a table explaining a frame number identifying method, according to an embodiment of the present invention; and

FIG. 3 is a table to explain a frame number identifying method, according to another embodiment of the present invention.

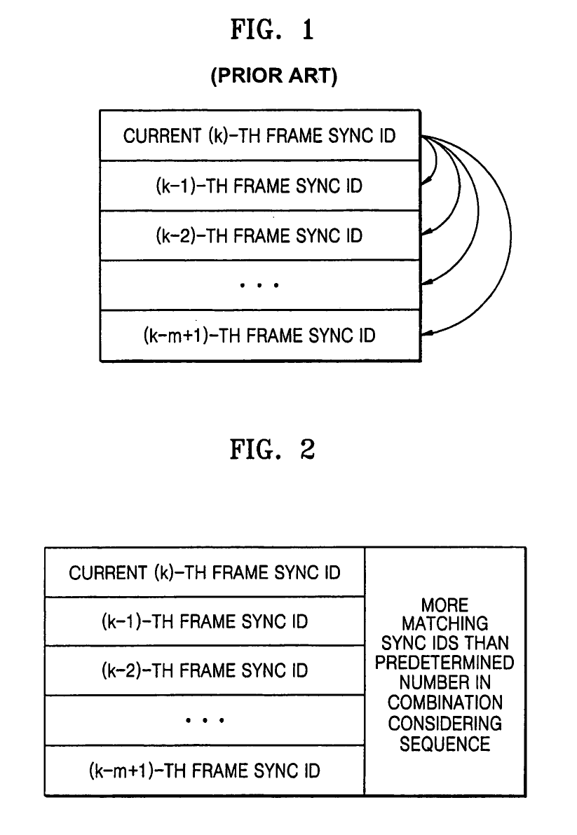

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

FIG. 2 is a table explaining a frame number identifying method, according to an embodiment of the present invention.

Referring to FIG. 2, a current frame (k-th frame) sync ID is not essential for identifying a current frame number. The current frame number can be identified, based on whether the number of matching sync IDs in an arbitrary combination, considering sequences of the sync ID of the current frame and sync IDs of m-1 preceding frames (k, k-1, k-2, . . . , k-m+1), is equal to or greater than r. The value of r can be set arbitrarily (here, 1<r<m+1, for example).

In a data decoding system having less frame sync IDs than frame numbers, a sync ID is given to each frame number. Different frames may have an identical sync ID. At a particular point of time, when the current frame sync ID is considered, the sync ID of a frame preceding by one frame is considered, the sync ID of a frame preceding by two frames is considered, . . . , and the sync ID of a frame preceding by (m-1) frames is considered, while the structure of the sync ID for an arbitrary frame is different from the structures of sync IDs for other frames.

It is assumed that the structure of sync IDs of frames preceding a current (k-th) frame through (m-1) frames is considered for each frame. The fact that two arbitrary frames may be unique or different is important, because the structure of the current frame sync ID and preceding sync IDs being unique can be utilized to determine a current frame number. Accordingly, by using r or more sync IDs among m sync IDs, as reference objects, including a current (k-th) frame sync ID, e.g., (k-th, (k-1)-th, (k-2)-th, . . . , (k-m+1)-th) (here, 1<r<m+1), a frame number can be identified.

Here, reference number r is variable according to the state of a system. Also, if the number of matching sync IDs is equal to or more than r, among m sync IDs forming the reference objects, a frame number can be identified, and thereafter it becomes unnecessary to detect a current (k-th) sync ID or to continuously detect error-free sync IDs.

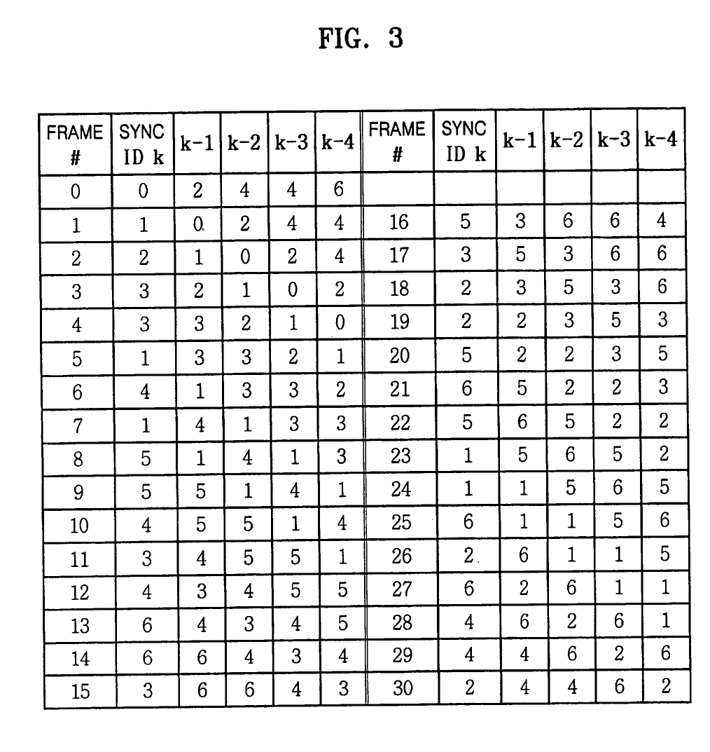

For example, when two arbitrary sync IDs are selected among the current frame sync ID and previous frame sync IDs, the current frame number needs a unique structure of sync IDs. As shown in FIG. 3, each of the 31 frame numbers has a single sync ID, of 7 predetermined sync IDs, and if two or more sync IDs are selected, considering sequence, for an arbitrary frame number, the combination can be unique.

Referring to FIG. 3, in order to identify a current frame number, the current frame sync ID and/or previous frame sync IDs are detected from input data. By determining whether the number of matching sync IDs, among m reference object frame sync IDs including the current frame sync ID, is equal to or greater than r, a frame number can be identified. In FIG. 3, a frame number can be identified with an arbitrary combination, considering a sequence of r or more sync IDs, of the current frame (k-th frame) sync ID and sync IDs of previous frames ((k-1)-th, (k-2)-th, (k-3)-th, (k-4)-th frames). At this time, value r may be set arbitrarily, with 1<r<m+1. Here, a frame number is identified according matching information of r sync IDs among m sync IDs. That is, if the identification considering level is r, a frame number can be identified when the number of matching sync IDs is equal to or greater than r among five sync IDs even though the current sync ID is not detected.

The present invention is used for a digital data decoding system, and can be applied to a data decoding circuit for a high-density optical recording medium system, in particular.

According to embodiments of the present invention, as described above, in such a digital data decoding system the speed of switching from an unstable state, e.g., an unlock state in which a sync pattern is not detected regularly, in the initial driving stage of the digital data decoding system, to a stable state, e.g., a lock stage in which a sync pattern is detected regularly, increases. In particular, identification of a frame number in such a situation where frame sync IDs repeat normal state—error—normal state—error—normal state becomes faster.

In embodiments of the present invention, even though an error-free current frame sync ID may not be existing in a stable state, if the number of matching sync IDs among sync IDs being compared is equal to or greater than a predetermined number (r), a current frame number can be recognized such that the frame number can be recognized faster and more stably than the conventional operation requiring the inserting a frame number based on simple prediction.

According to embodiments of the present invention, by varying the number of frames required for identifying a frame number, the system can also be set according to the characteristics, so that maximum effects can be achieved. As a result, identification of a frame number becomes faster and reliability increases.

Furthermore, embodiments of the present invention increase error correction capability when error correction decoding is performed after the accurate identification of a frame number, such that the decoding performance of the entire system improves. As described above, embodiments of the present invention have been described generally in process terms, though the present invention isn't limited thereto. Additional embodiments include the aforementioned data decoding system implementing the described processes and a medium including computer readable code controlling the implementation of the same. A medium can include any media capable of providing the computer readable code, e.g., an optical recording disc, storage devices, wired and wireless systems, and wave guides, etc.

Although a few embodiments of the present invention have been shown and described, it would be appreciated by those skilled in the art that changes may be made in this embodiment without departing from the principles and spirit of the invention, the scope of which is defined in the claims and their equivalents.

1. A data decoding method, comprising:
detecting sync identification data (ID) of a current frame and/or sync IDs of previous frames from input data; and
identifying a frame number according to whether a number of matching sync IDs in a combination, considering a sequence of detected sync ID of the current frame and/or sync IDs of previous frames, is equal to or greater than a predetermined number.

2. The method of claim 1, wherein in the identifying of the frame number, even when the sync ID of the current frame is not detected, the frame number is identified.

3. The method of claim 1, wherein in the identifying the frame number, even when the detected frame sync IDs are not continuous, the frame number is identified.

4. The method of claim 1, wherein in the identifying of the frame number, a number of sync IDs of previous frames to be combined is variably set.

5. A frame number identifying method of a data decoding system having less frame sync IDs than frame numbers for input data, comprising:
detecting a sync ID of a current frame and/or sync IDs of previous frames from the input data; and
identifying a frame number according to whether a number of matching sync IDs in a combination is equal to or greater than a predetermined number r, by using a uniqueness within the combination, considering a sequence of m sync IDs including the current frame and/or sync IDs of previous frames.

6. The method of claim 5, wherein in the identifying of the frame number, even when the sync ID of the current frame is not detected, the frame number is identified.

7. The method of claim 5, wherein in the identifying of the frame number, even when the detected frame sync IDs are not continuous, the frame number is identified.

8. The method of claim 5, wherein in the identifying of the frame number, a number of sync IDs of previous frames in the combination is variably set.

9. The method of claim 5, wherein a value for r is set arbitrarily such that 1<r<m+1.

10. The method of claim 5, wherein the detected sync IDs are not error-free.

11. A medium, comprising computer readable code to control a:
detecting of sync identification data (ID) of a current frame and/or sync IDs of previous frames from input data; and
identifying of a frame number according to whether a number of matching sync IDs in a combination, considering a sequence of detected sync ID of the current frame and/or sync IDs of previous frames, is equal to or greater than a predetermined number.

12. The medium of claim 12, wherein in the identifying of the frame number, even when the sync ID of the current frame is not detected, the frame number is identified.

13. The medium of claim 12, wherein in the identifying the frame number, even when the detected frame sync IDs are not continuous, the frame number is identified.

14. The medium of claim 12, wherein in the identifying of the frame number, a number of sync IDs of previous frames to be combined is variably set.

15. A medium, comprising computer readable code controlling a frame number identifying operation of a data decoding system having less frame sync IDs than frame numbers for input data, controlling a:
detecting of a sync ID of a current frame and/or sync IDs of previous frames from the input data; and
identifying of a frame number according to whether a number of matching sync IDs in a combination is equal to or greater than a predetermined number r, by using a uniqueness within the combination, considering a sequence of m sync IDs including the current frame and/or sync IDs of previous frames.

16. The medium of claim 16, wherein in the identifying of the frame number, even when the sync ID of the current frame is not detected, the frame number is identified.

17. The medium of claim 16, wherein in the identifying of the frame number, even when the detected frame sync IDs are not continuous, the frame number is identified.

18. The medium of claim 16, wherein in the identifying of the frame number, a number of sync IDs of previous frames in the combination is variably set.

19. The medium of claim 16, wherein a value for r is set arbitrarily such that 1<r<m+1.

20. The medium of claim 16, wherein the detected sync IDs are not error-free.

21. A data decoding system, comprising:
a detector to detect sync identification data (ID) of a current frame and/or sync IDs of previous frames from input data; and
an identifier to identify a frame number according to whether a number of matching sync IDs in a combination, considering a sequence of detected sync ID of the current frame and/or sync IDs of previous frames, is equal to or greater than a predetermined number.

22. The system of claim 23, wherein in the identifying of the frame number, even when the sync ID of the current frame is not detected, the frame number is identified.

23. The system of claim 23, wherein in the identifying the frame number, even when the detected frame sync IDs are not continuous, the frame number is identified.

24. The system of claim 23, wherein in the identifying of the frame number, a number of sync IDs of previous frames to be combined is variably set.

25. A data decoding system, wherein input data includes less frame sync IDs than frame numbers, comprising:
a detector to detect a sync ID of a current frame and/or sync IDs of previous frames from the input data; and
an identifier to identify a frame number according to whether a number of matching sync IDs in a combination is equal to or greater than a predetermined number r, by using a uniqueness within the combination, considering a sequence of m sync IDs including the current frame and/or sync IDs of previous frames.

26. The system of claim 27, wherein in the identifying of the frame number, even when the sync ID of the current frame is not detected, the frame number is identified.

27. The system of claim 27, wherein in the identifying of the frame number, even when the detected frame sync IDs are not continuous, the frame number is identified.

28. The system of claim 27, wherein in the identifying of the frame number, a number of sync IDs of previous frames in the combination is variably set.

29. The system of claim 27, wherein a value for r is set arbitrarily such that 1<r<m+1.

30. The system of claim 27, wherein the detected sync IDs are not error-free.
